(19) United States
(12) Patent Application Publication
(10) Pub. No.: US 2026/0120306 A1
(43) Pub. Date: Apr. 30, 2026

(54) SYSTEM AND METHOD FOR DETERMINING INSTALLATION OF ACCESSIBILITY FEATURES USING MACHINE LEARNING AND AUTOMATED VERIFICATION

(71) Applicants: Susan L. Kimmel, Washington, DC (US); Louis Tenenbaum, Kensington, MD (US); Seymour Turner, Chicago, IL (US); Rob Germaine, Arlington, VA (US)

(72) Inventors: Susan L. Kimmel, Washington, DC (US); Louis Tenenbaum, Kensington, MD (US); Seymour Turner, Chicago, IL (US); Rob Germaine, Arlington, VA (US)

(21) Appl. No.: 19/432,623

(22) Filed: Dec. 24, 2025

Related U.S. Application Data
(63) Continuation-in-part of application No. 18/149,977, filed on Jan. 4, 2023, now abandoned.
(60) Provisional application No. 63/266,379, filed on Jan. 4, 2022.

(51) Int. Cl. G06T 7/60; G06T 7/70; G06T 19/00

(52) U.S. Cl. CPC G06T 7/60; G06T 7/70; G06T 19/006; G06T 2207/20081; G06T 2207/20084; G06T 2210/04

(57) ABSTRACT

A system and method for determining the location and installation techniques of accessibility features using machine learning-based personalized planning for users with specialized functional limitations, whole-room multi-support optimization, and automated photo-based verification using computer-vision detection, job-specific tokens, and non-reversible geometry fingerprints to ensure compliance with installation plans and prevent reuse of verification images across different jobs.

### CROSS-REFERENCE TO RELATED APPLICATION

This application claims the benefit of priority of U.S. non-provisional application Ser. No. 18/149,977, filed Jan. 4, 2023, as a Continuation-in-Part (CIP), the contents of which are herein incorporated by reference. Though that parent application, this CIP application claims the benefit of priority of U.S. provisional application No. 63/266,379, filed Jan. 4, 2022, the contents of which are herein incorporated by reference.

### BACKGROUND OF THE INVENTION

The present invention relates to residential and commercial modifications and, more particularly, to systems and methods for determining the location and installation techniques for accessibility features using machine learning-based planning and automated photo-based verification, wherein the system provides personalized installation plans for individuals with specialized functional limitations and verifies compliance through computer-vision analysis of installation images.

For older adults who wish to age in place or physically disabled individuals who desire independence, their home may require the installation of accessibility features, including but not limited to grab bars, poles, railings, ramps, and the like. Currently there is no efficient process for doing so because, in part, of the following problems: the contractor or handyman does not know the best location or best method of installation; an occupational therapist is consulted but this is an additional step and cost which requires follow up by the homeowner; and there is no means of verification that the work was completed properly whether performed by a contractor or as a do-it-yourself project.

While online videos and design guidelines exist for installation of accessibility features, many are based on tradition or standards developed for new construction where behind the wall blocking is part of the design. Under a grant from the National Institutes on Aging, a business concern of the applicant, Homes Renewed Ventures (HRV), engaged a panel of experts to develop universal-design standards intended to accommodate a typical or average user population. The parent application was geared to this population. However, such standards do not account for individuals with specialized functional limitations, such as post-stroke hemiparesis affecting one side of the body, reduced range of motion, use of support elements, or balance impairments that place the individual outside of the typical user population. Moreover, existing software application solutions do not provide a method of optimizing the number, type, and placement of multiple support elements throughout an entire room based on the specific needs of an individual or a cohort of similarly situated individuals.

Furthermore, existing systems lack robust mechanisms for verifying that accessibility features were properly installed according to the generated installation plan. Because the installation of accessibility features typically does not require a building permit, building inspectors are not engaged in these small projects. Self-certification by installers is unreliable, and manual inspection by occupational therapists or trained reviewers adds significant time and cost. There is no automated, photo-based verification system that uses computer-vision techniques to detect installed support elements, compare their positions and orientations to a planned configuration, and ensure that verification images are authentically associated with the correct job and have not been reused from a different installation. Such an advance is the technology is important when installers are hired to install safety features across a plurality of different rooms—for instance, in a nursing home—where remote verification would save employers of the installers, as opposed to being forced to make a job site visit.

As can be seen, there is a need for a system and method that: (1) generates personalized installation plans for individuals with specialized functional limitations using machine learning trained on expert-approved and synthetic scenarios; (2) optimizes the number, type, and placement of support elements throughout an entire bathroom based on the room geometry and the user's functional profile; and (3) performs automated photo-based verification of completed installations using computer-vision detection, job-specific tokens, and non-reversible geometry fingerprints to ensure compliance with the installation plan and prevent reuse of verification images across different jobs.

### SUMMARY OF THE INVENTION

The present disclosure extends the system and method described in the parent application to include machine learning-based personalized installation planning, whole-room multi-support optimization, and automated photo-based verification using computer-vision techniques.

In certain embodiments, the system generates personalized installation plans for users having specialized functional limitations that differ from a typical user population. The system receives site-specific input data describing a bathroom, including at least the locations and dimensions of fixtures, and structural information such as wall type. The system receives a functional profile for an intended user, comprising parameters such as user height, reach range, hand dominance, use of a support elements, balance or fall-risk classification, and side-specific strength or range-of-motion limitations. In some embodiments, the functional profile includes a cohort identifier associating the user with a group of similarly situated users, such as post-stroke users exhibiting right-side hemiparesis.

A planning module uses the bathroom data and the functional profile as inputs to a machine-learned model trained on expert-approved installation plans and synthetic scenarios. The model maps the combination of site features and user functional parameters to candidate configurations of support elements. A rule-enforcement module constrains each configuration to satisfy structural and safety rules derived from human-factors, universal-design, and construction experts. The system outputs installation instructions including, for each support element, at least a type, position, and orientation. In some embodiments, the system outputs a confidence score indicating whether the configuration should be reviewed by a clinician prior to installation.

In additional embodiments, the system performs whole-room optimization of support elements. Rather than limiting the solution to a fixed number of grab bars at predefined locations, the system determines an appropriate number, type, and arrangement of support elements throughout an entire bathroom based on room geometry and the user's functional profile. The planning module proposes candidate support elements and a machine-learned model trained on expert-designed and synthetic multi-support layouts selects a subset that optimizes objectives such as coverage of critical transfer paths, safety margins, and hardware efficiency, subject to expert-defined constraints.

In further embodiments, the system performs photo-based verification of completed installations using computer-vision techniques. The system associates a unique job token with a job identifier, wherein the job token is configured to be presented within a field of view of a camera during capture of verification images. Upon receiving verification images from a mobile device operated by an installer, the system applies computer-vision models to detect image regions corresponding to the job token and the installed support elements. The system computes a geometry descriptor representing spatial relationships between walls, fixtures, and installed supports, and generates a non-reversible fingerprint from the geometry descriptor. By comparing the detected job token and the non-reversible fingerprint to stored verification records, the system determines whether the verification images are authentically associated with the job identifier and whether the geometry fingerprint has been previously stored for a different job, thereby preventing reuse of verification images. The system further compares detected locations and orientations of installed support elements to the installation plan to determine conformance within specified tolerances, and outputs a verification result indicating both image authenticity and installation compliance.

In some embodiments, bathroom site data is acquired in whole or in part by sensor-based measurement, such as depth-enhanced images or lidar scans captured by a mobile device, and the system may generate augmented-reality visualizations that superimpose virtual representations of planned support elements on live or recorded images of the bathroom to guide installers.

These techniques provide a closed-loop workflow: plan generation using machine learning and expert rules, installation guidance using augmented-reality visualization, and post-installation verification using computer-vision detection and geometry fingerprinting, for both typical users and users with complex functional needs.

These and other features, aspects and advantages of the present invention will become better understood with reference to the following drawings, description, and claims.

### BRIEF DESCRIPTION OF THE DRAWINGS

FIGS. 1A, 1B, and 1C are flowcharts of an exemplary embodiment of a computer-implemented workflow for planning and verifying installation of accessibility features, illustrating interactions among an installer, a mobile application, and a backend verification system.

FIG. 2 is a schematic view of an exemplary computing environment suitable for implementing embodiments of the subject disclosure, including one or more processors, storage devices, input devices, and output devices. The exemplary schematic diagram of the overall system architecture includes: Mobile Device 300 with camera 302, depth sensor 304, and mobile application 30, Backend Server 400 with database 402, ML models 404, rule engine 406, and verification module 408, Communication network 310 connecting mobile device to backend server, Data flows showing: site data capture→ML-based planning→installation→verification.

FIG. 3 is a top-down schematic view of an exemplary personalized configuration of support elements for a post-stroke user, illustrating placement of grab bars and a support pole based on a functional profile and bathroom geometry. In this example, the following are provided: Bathroom outline 600; Bathtub 602 positioned along long wall; Toilet 604 positioned along short wall; Support Element 610: Horizontal grab bar on LEFT side of bathtub (emphasized for left-hand dominance); Support Element 612: Vertical grab bar at bathtub entry; Support Element 614 (Floor-to-ceiling pole near toilet); User reach range overlay 620 (shown as arc from left side, indicating reduced right-side reach) showing, here, mounting heights, distances from fixtures, cohort identifier ‘post-stroke-right-hemiparesis’.

FIG. 4 is a flowchart schematic view of an exemplary computer-vision detection process for identifying job tokens and installed support elements in verification images, wherein this exemplary process includes the following: Step 1200: Receive verification image from mobile device; Step 1202: Apply CV Model #1 Job Token Detection involving Raw image 1210 input with CNN architecture 1212 (layers shown: conv, pool, fc), resulting in Output of token bounding box 1214, Job ID extracted 1216; Step 1204: Apply CV Model #2—Support Element Detection including same image 1210 input and Object detection network 1220 (YOLO/Faster R-CNN architecture), resulting in Bounding boxes 1222 output for each detected grab bar/pole; Classification 1224 (horizontal bar, vertical bar, pole, etc.)l Position/orientation estimates 1226; Step 1206: Extract reference features (fixture edges, wall corners); and Step 1208: Compute relative positions and orientations.

FIG. 5 is a diagrammatical view of an exemplary process for generating a non-reversible geometry fingerprint from a geometry descriptor derived from verification images, showing fingerprint creation and privacy protection involving the following components. Exemplary Inputs: Geometry Descriptor 1400, Hash Function 1410, SHA-256 cryptographic hash shown, Input data flow 1412, One-way transformation 1414 (emphasized with arrow); Exemplary Outputs: Non-Reversible Fingerprint 1420, 56-bit hash value (shown as hexadecimal string); Exemplary Privacy Protection Engine 1430 including: Verification image 1432 with strikethrough (not stored long-term), Geometry descriptor 1434 with strikethrough (not stored long-term), and Fingerprint 1436 with checkmark (stored indefinitely)l and Exemplary Non-Reversibility 1440 (showing failed reverse hash attempt with X).

FIG. 6 is a flowchart of an exemplary token validation and verification process, illustrating association of verification images with a job identifier and detection of image reuse across different jobs through, here, the following exemplary verification process including the following components: Step 1600: Generate and display job token on mobile device; Step 1602: Installer captures verification images with token visible; Step 1604: Upload images to backend server; Step 1606: Detect job token, extract job identifier; Decision 1608: Token detected and valid? <If NO→1609: Verification FAIL—Invalid token; If YES→Continue to>Step 1610: Detect installed support elements.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, embodiments of the present invention provide computer-implemented systems and methods for determining the location and installation techniques of accessibility features using machine learning-based personalized planning, whole-room multi-support optimization, and automated photo-based verification coupled to a system for verifying compliance with the identified installation techniques.

The present continuation-in-part application incorporates by reference all features, systems, and methods disclosed in the parent application Ser. No. 18/149,977 These features include but are not limited to: receiving client data and site configuration data; determining compliant accessibility feature solutions from a database of expert-curated specifications; identifying installation instructions based on site configuration and structural data; displaying installation steps sequentially conditioned on receiving electromagnetically sensed documentation (captured images) for each step; generating virtual job space representations; prompting for pre-installation documentation of marked location points; collecting structural data including wall materials and substrates; evaluating installation-step documentation for compliance; providing corrective instructions or workarounds when variations are detected; and issuing certificates of compliance upon completion of all installation steps.

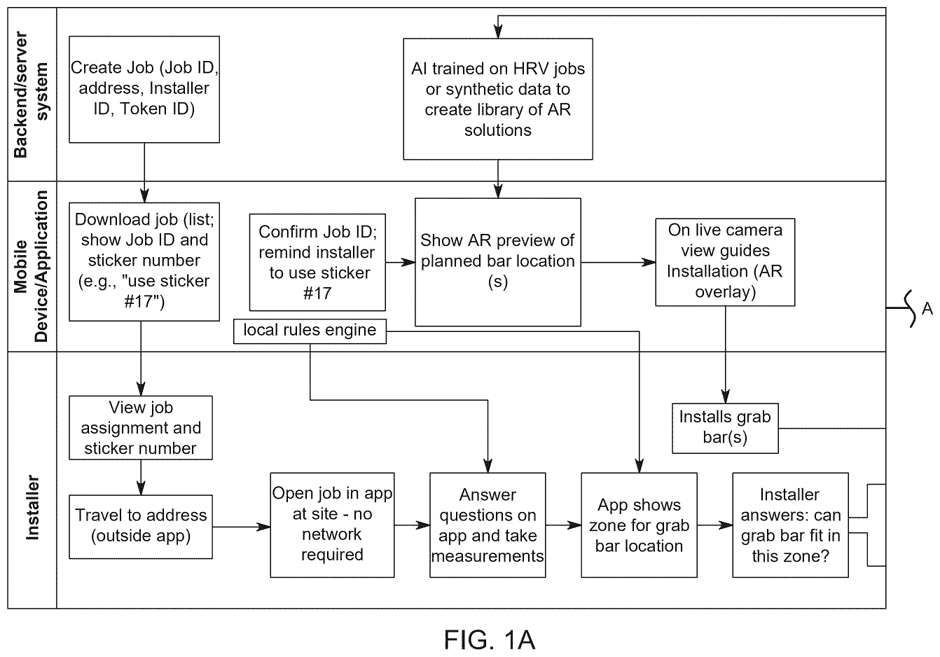

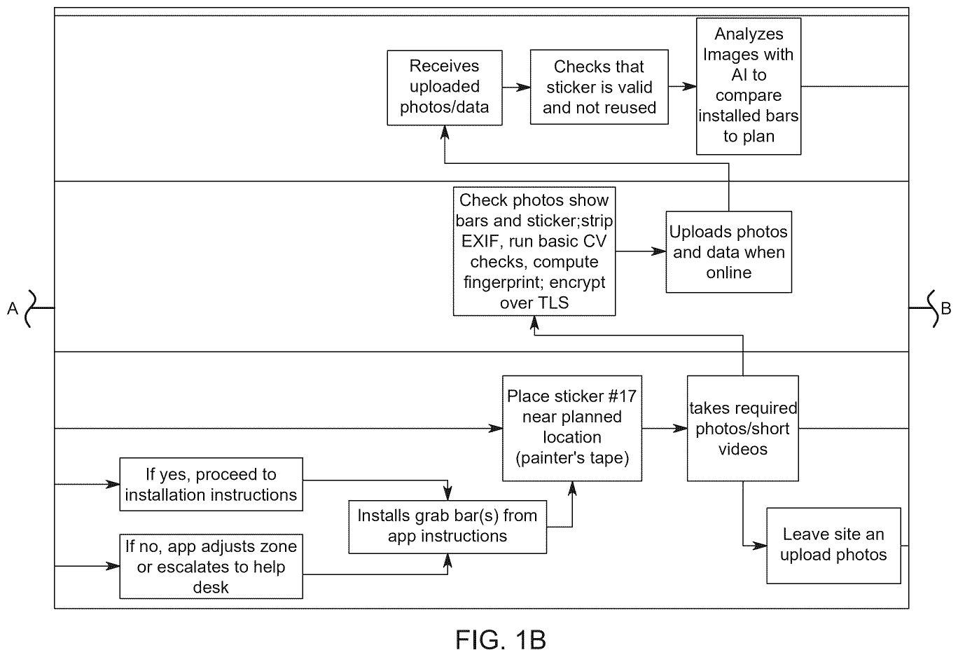

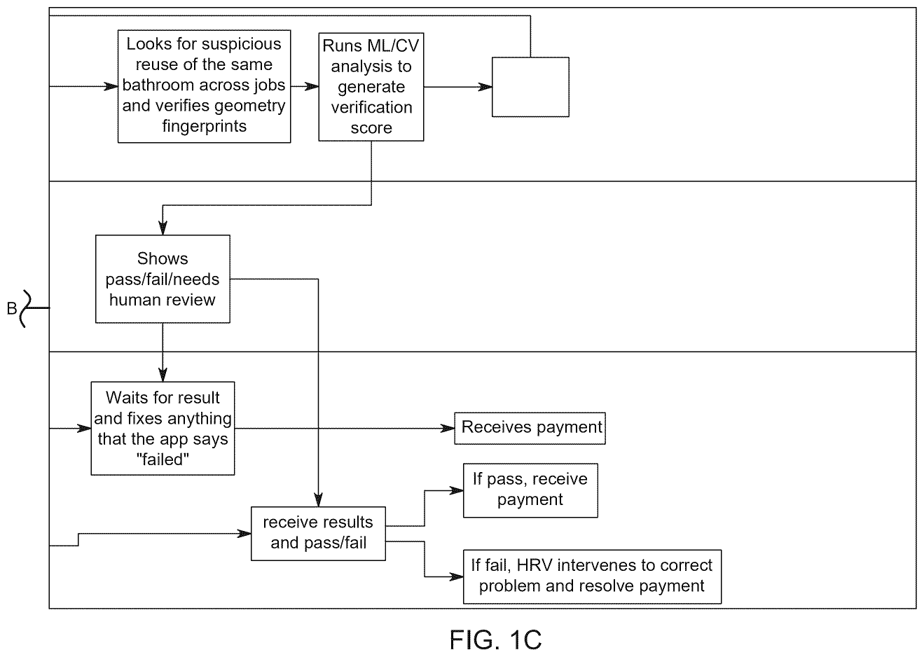

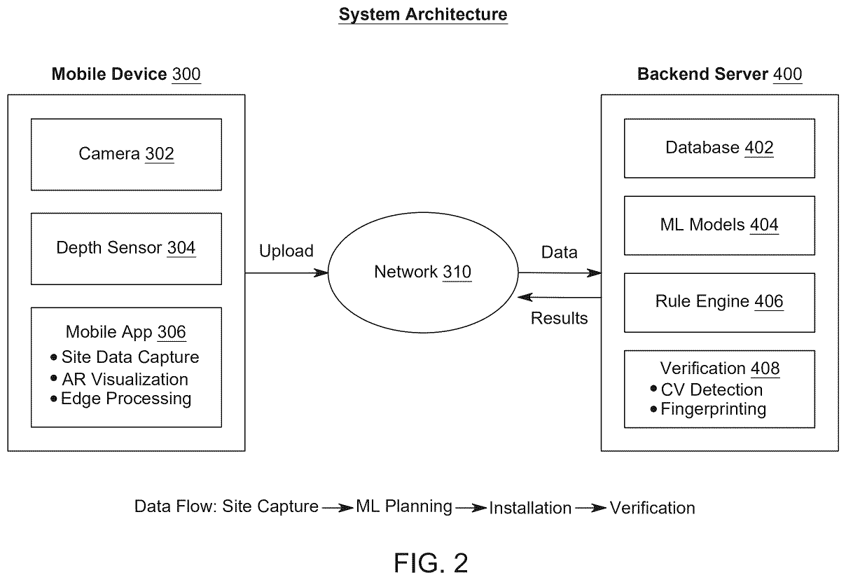

Referring to FIGS. 1A and 1B, the present continuation-in-part extends these foundational capabilities by adding machine learning-based personalized planning for users with specialized functional limitations, whole-room multi-support optimization, and automated computer-vision-based verification with job-specific tokens and non-reversible geometry fingerprints.

### Machine Learning-Based Personalized Installation Planning

Prior embodiments of the applicant's system utilized a rules engine to position a fixed number of grab bars according to universal-design principles intended to accommodate approximately eighty percent of the general population. Users whose needs fell outside this default population were screened out and referred to human experts such as physical therapists, occupational therapists, or specialized designers.

In certain embodiments disclosed herein, the system is extended to generate personalized installation plans for users having specialized functional limitations and for cohorts of similarly situated users. The system receives, in addition to bathroom geometry and structural information, a functional profile describing parameters such as user height, reach range, hand dominance, side-specific strength or range-of-motion limitations (e.g., right-side hemiparesis following stroke), use of support elements, and balance or fall-risk classification.

A machine-learned model is trained on a training dataset comprising expert-approved installation plans and associated functional profiles. The expert-approved installation plans may be derived from actual clinical or design practice and/or from synthetic scenarios generated by applying expert rules to hypothetical bathrooms and user profiles. The training process ensures that the model learns from high-quality, safety-compliant examples rather than arbitrary real-world data that may contain incorrect or unsafe installations.

The trained machine-learned model maps the combination of site features (bathroom dimensions, fixture locations, wall types, available mounting regions) and user functional parameters to at least one candidate configuration of grab bars and other support elements appropriate for the individual user or cohort. In some embodiments, the model is a neural network, decision tree ensemble, or other supervised learning model. In other embodiments, the model may be a reinforcement learning agent trained to optimize placement configurations according to safety objectives, user-specific constraints, and/or project cost.

A rule-enforcement module constrains each candidate configuration generated by the machine-learned model to satisfy a set of structural and safety rules. These rules are derived from human-factors, universal-design, and construction experts and include criteria such as minimum and maximum mounting heights, permissible orientations, required clearances, and permissible attachment regions given wall type and available backing. The rule-enforcement module operates as a post-processing filter, rejecting or modifying any machine-learned outputs that violate hard safety or structural constraints, thereby ensuring that personalized plans are both user-specific and rule-compliant.

The system outputs installation instructions for the individualized configuration, including, for each support element, at least a type (horizontal bar, vertical bar, angled bar, floor-to-ceiling pole), position (coordinates relative to fixtures and walls), and orientation (angle, mounting surface). In some embodiments, the system further outputs a confidence score or a classification indicating whether the generated configuration is suitable for direct use by an installer or should be reviewed and approved by a clinician, such as a physical therapist or occupational therapist, prior to installation. Configurations with low confidence scores or those involving rare or complex functional profiles may be flagged for expert review, while configurations with high confidence scores for well-represented cohorts may proceed directly to installation.

In this manner, the system is enabled to provide personalized installation instructions for at least a subset of users who, in prior embodiments, would have been excluded from automated planning workflows and referred entirely to manual PT/OT or designer intervention. This represents a technical advancement in the planning capability of the system, enabling it to serve a broader user population while maintaining safety and compliance through hybrid machine learning and rule-based enforcement.

### Example Embodiment: Functional Profile for Post-Stroke User

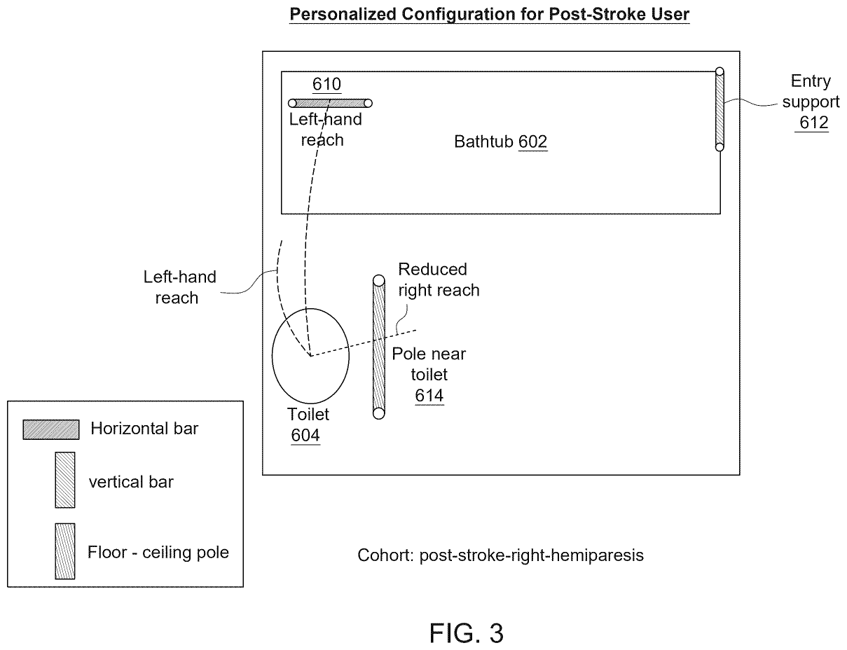

Referring to FIG. 3, in an example embodiment, a user has experienced a stroke resulting in right-side hemiparesis, characterized by reduced strength and range of motion in the right upper and lower extremities. The user's functional profile includes the following parameters: user height of 170 cm; reduced reach range on the right side of 30 cm below normal; left-hand dominance due to impaired right-hand function; use of a cane for ambulation; moderate fall-risk classification; and cohort identifier “post-stroke-right-hemiparesis.”

The system receives site-specific input data for the user's bathroom, including dimensions of 200 cm by 150 cm, a bathtub positioned along the long wall, and a toilet positioned adjacent to the short wall. Structural information indicates standard drywall with wooden studs at 16-inch spacing and tile surfaces in the bathing area. The planning module inputs the bathroom data and the functional profile into the machine-learned model. The model, having been trained on expert-approved layouts for post-stroke users with right-side hemiparesis, outputs a candidate configuration that includes: a horizontal grab bar positioned on the left wall of the bathtub at a height accessible by the user's left hand and within the reduced reach range; a vertical grab bar positioned at the bathtub entry point to assist with transfers; and a floor-to-ceiling pole positioned near the toilet to provide additional stability when the user's right side is less able to provide support. The candidate configuration accounts for the user's left-hand dominance and positions support elements primarily on the left side or within left-hand reach.

The rule-enforcement module verifies that each support element in the candidate configuration satisfies structural and safety rules: the horizontal bar mounting height is within the permissible range for bathtub grab bars; the vertical bar is positioned to avoid interference with the bathtub faucet and shower controls; the floor-to-ceiling pole is positioned to provide adequate clearance from the toilet and walls; and mounting locations take into account available wooden studs, other backing materials, or specifies hardware designed for hollow wall cavities designed to withstand applied stresses. The rule-enforcement module confirms compliance and the configuration is approved.

The system outputs installation instructions specifying the type, position, and orientation of each support element, along with a confidence score of 0.92 indicating high confidence based on the model's training on similar post-stroke, right-hemiparesis cases. The installer proceeds with installation without requiring prior clinical review. This embodiment illustrates how the system uses the functional profile and structural data to generate a personalized, rule-compliant configuration that would previously have required manual clinician design.

### Whole-Room Multi-Support Optimization

In some embodiments, the system is configured to generate an optimized configuration of support elements for an entire bathroom, rather than a fixed number of grab bars at predefined locations associated with specific fixtures. The system receives site data describing the geometry and fixtures of a bathroom, including at least the dimensions of the room, the locations of walls, doors, bathing fixtures, and toilets, and optionally structural information such as wall type (e.g., plaster on lath, drywall on wood or metal studs, brick, concrete block, etc.) and stud spacing. The system also receives a functional profile for an intended user, the functional profile including one or more parameters indicative of mobility limitations, balance or fall risk, side-specific weakness, use of support elements, and/or membership in a functional cohort.

Based on the site data and the functional profile, a planning module determines a set of candidate support elements. The candidate set includes but is not limited to horizontal grab bars, vertical grab bars, angled grab bars, and floor-to-ceiling poles. The candidate elements are positioned not only adjacent to fixtures (bathing and toileting) but also along transfer paths, near room entry points, and in open areas where balance support may be needed.

A machine-learned model, trained on expert-designed and/or synthetic scenarios that associate bathroom layouts and functional profiles with expert-approved multi-support configurations, evaluates and selects a subset of the candidate support elements and associated mounting locations to form a multi-support layout. The model is trained to balance multiple objectives, such as providing coverage of critical transfer paths (e.g., from door to toilet, from toilet to bathing fixture, from bathing fixture to exit), minimizing the number of supports (to reduce installation cost and visual clutter), ensuring structural feasibility (mounting locations correspond to available studs or backing), and complying with safety rules (minimum clearances, maximum reach distances, permissible mounting heights).

In some embodiments, the optimization objective is formulated as a multi-objective optimization problem, and the machine-learned model is trained using reinforcement learning or evolutionary algorithms to find configurations that achieve high scores across all objectives. In other embodiments, the model uses a weighted sum of objectives or a lexicographic ordering of objectives to prioritize certain factors over others. For example, safety and coverage of critical transfer paths may be prioritized over minimizing the number of supports.

A rule-enforcement module constrains the selected multi-support layout to satisfy structural and safety constraints specified by human-factors, universal-design, and construction experts. The resulting layout may include more or fewer supports than a fixed baseline configuration and may incorporate supports at locations other than the bathing and toileting fixtures. For example, the layout may include a grab bar near the door to assist with entry and exit, a floor-to-ceiling pole in the center of the room to provide balance support during transfers, and multiple bars at different heights and orientations to accommodate varying user postures and transfer techniques.

The system outputs installation instructions that specify, for each support element in the optimized layout, its type, position, orientation, and required mounting hardware. The instructions may include a visual representation of the multi-support layout superimposed on a floor plan or three-dimensional model of the bathroom to assist the installer in understanding the overall configuration.

This whole-room optimization capability improves the technical performance of the system by allowing it to automatically compute room-wide support configurations that were previously designed manually or not provide at all, thereby increasing safety coverage for high-risk users while maintaining structural feasibility and cost efficiency.

### Example Embodiment: Whole-Room Optimization for High Fall-Risk User

In an example embodiment, a user has been classified as high fall-risk due to a combination of factors including advanced age, balance impairments, and use of a walker for ambulation. The user's functional profile includes parameters indicating high fall-risk classification, use of a walker, and reduced balance. The bathroom has dimensions of 250 cm by 200 cm, with a walk-in shower with a curb along one long wall, a toilet along the opposite long wall, and a sink near the entry door.

The planning module determines a set of candidate support elements including multiple horizontal grab bars at the shower, vertical grab bars at the shower entry, a grab bar near the toilet, a grab bar near the sink, a floor-to-ceiling pole positioned centrally in the room to provide balance support during transfers, and additional grab bars along the walls to provide continuous support along transfer paths.

The machine-learned model evaluates the candidate elements and selects a subset that optimizes coverage of critical transfer paths while satisfying structural and safety constraints. The selected multi-support layout includes: two horizontal grab bars at different heights inside the shower to accommodate different postures; a vertical grab bar at the shower entry to assist with stepping over the curb; a horizontal grab bar mounted to the right of the toilet; a grab bar near the sink to assist with standing from the toilet and walking to the sink; a floor-to-ceiling pole positioned centrally to provide balance support during the transfer from toilet to sink and from sink to shower; and an additional horizontal grab bar near the entry door to assist with entering and exiting the bathroom.

The rule-enforcement module verifies that all mounting locations use hardware appropriate to the particular wall construction,, that clearances are maintained to avoid interference with the walker, and that mounting heights are within permissible ranges. The optimized layout includes a total of seven support elements, which is more than the fixed baseline configuration of three elements (two at bathing, one at toileting) used in prior embodiments. This whole-room optimization provides comprehensive support tailored to the high fall-risk user's needs, the specific geometry of the bathroom, and can accommodate anticipated future changes such as progression to wheelchair use.

### Sensor-Based Data Acquisition and Augmented-Reality Visualization

In some embodiments, the site data describing the bathroom geometry is derived at least in part from sensor-acquired information. A mobile device, such as a smartphone or tablet, equipped with depth-sensing capabilities or lidar scanning capabilities, is used to capture depth-enhanced images or lidar scans of the bathroom. The sensor data provides three-dimensional spatial information about the locations and dimensions of walls, fixtures, and obstructions.

A processing module analyzes the sensor data to automatically extract geometric features such as wall planes, floor planes, fixture locations, and dimensions. The processing module may use point cloud processing techniques, plane-fitting algorithms, and object recognition models to identify and measure bathroom features. This automated measurement reduces the need for manual tape measurements and reduces measurement errors, improving the accuracy of the site data used for computer-implemented planning.

In further embodiments, the system generates an augmented-reality (AR) visualization in which virtual representations of the selected support elements are superimposed on a live or recorded image of the bathroom. The AR visualization is displayed on the mobile device and guides the installer to the optimized locations before installation. The installer can view the candidate accessory features for the bathroom displayed by the mobile device camera to see virtual grab bars, poles, and other support elements overlaid on the real-world view at their planned positions and orientations. This provides intuitive spatial guidance and reduces installation errors by showing the installer exactly where to drill and mount each element. The AR visualization may include annotations indicating mounting heights, distances from fixtures, and alignment guides to assist the installer.

In some embodiments, the AR visualization dynamically updates as the installer moves the mobile device, maintaining accurate registration of virtual elements with the real-world bathroom geometry, for example by continuously estimating camera pose relative to detected planes and features.

### Automated Photo-Based Verification Using Computer Vision, Job Tokens, and Geometry Fingerprints

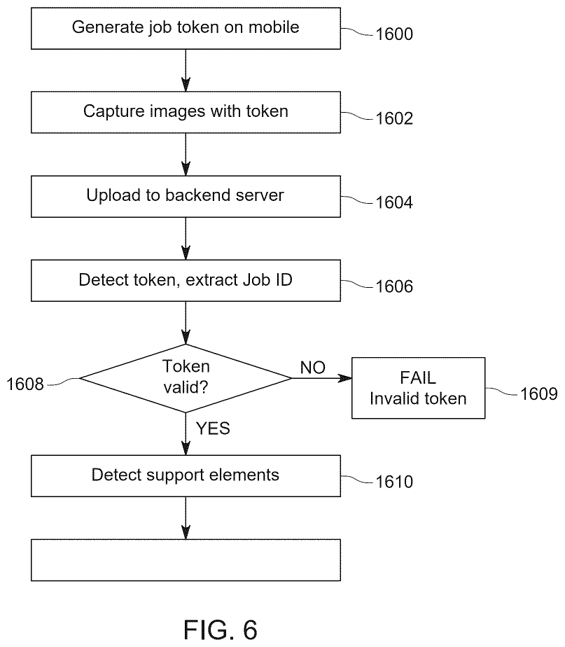

Referring to FIG. 6, in further embodiments, the system performs automated photo-based verification of completed installations using computer-vision techniques, job-specific tokens, and non-reversible geometry fingerprints. This verification workflow ensures that installed support elements conform to the installation plan and that verification images are authentically associated with the correct job and have not been reused from a different installation.

### Job Token Association

Referring to FIG. 6, the system associates a unique job token with a job identifier for each installation job. The job token may be a visual marker such as a QR code, barcode, alphanumeric code displayed on a card or printed sheet, or a machine-readable pattern. The job token is configured to be presented within the field of view of a camera during capture of verification images. In some embodiments, the job token is displayed on the mobile device screen and the installer positions the mobile device such that the token is visible in the verification image. In other embodiments, the job token is a physical card or sticker that the installer places in the bathroom before capturing verification images.

The job token serves as a visual identifier that binds the verification images to the specific job identifier. By detecting the job token in the verification images, the system can confirm that the images were captured for the intended installation job and not for a different job or location.

### Computer-vision Detection of Installed Support Elements and Job Tokens

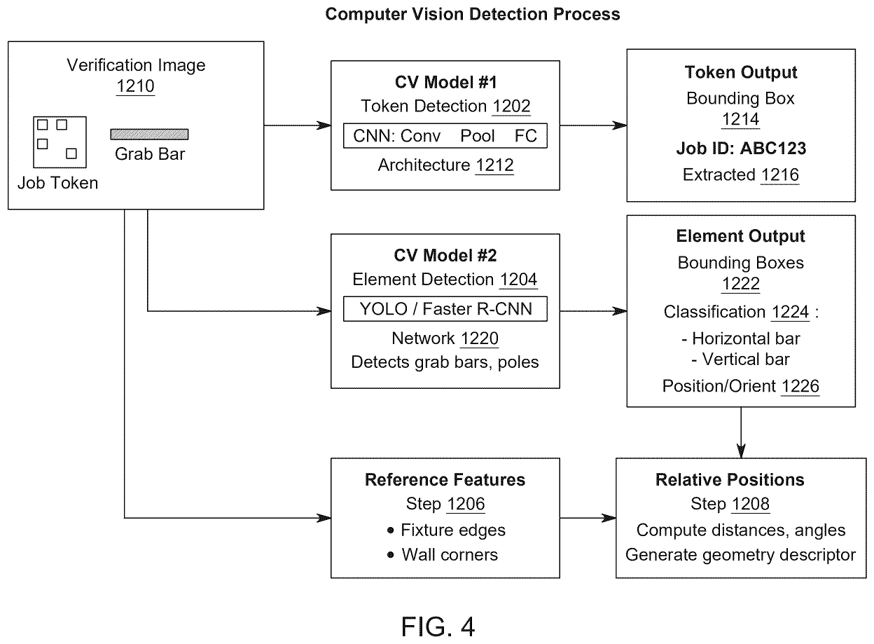

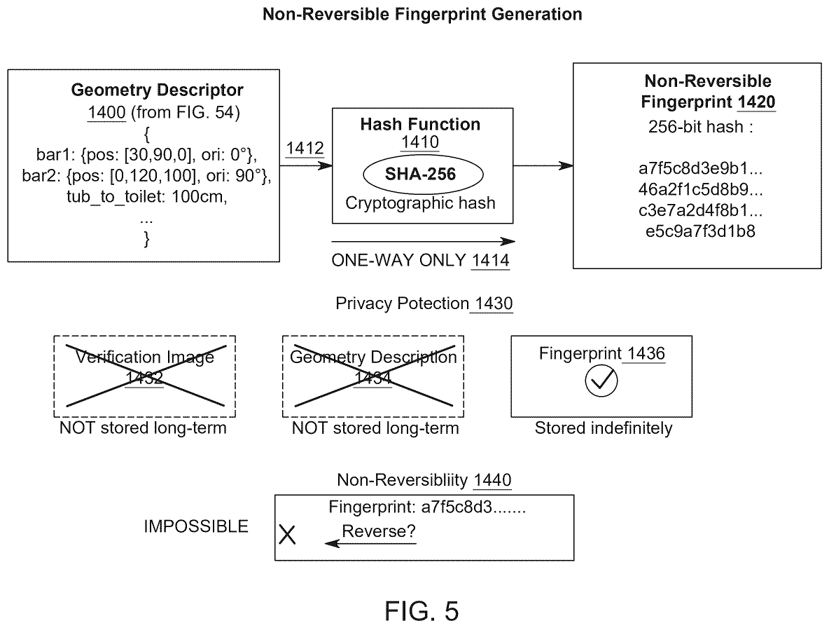

Referring to FIG. 4, upon receiving one or more verification images from a mobile device operated by an installer, the system applies one or more computer-vision models to the verification images. The computer-vision models are trained to detect image regions corresponding to the job token and to the installed support elements.

A first computer-vision model detects the image region corresponding to the job token. The model may be a convolutional neural network (CNN) trained to recognize QR codes, barcodes, or specific visual patterns associated with job tokens. Upon detecting the job token, the model extracts the job identifier encoded in or associated with the token. This extracted job identifier is used to associate the verification images with the corresponding installation plan stored in the system database.

A second computer-vision model detects one or more image regions corresponding to the installed support elements. The model may be a CNN trained to recognize grab bars, floor-to-ceiling poles, and other support elements in bathroom images. The training dataset for this model includes images of various types of support elements in different bathroom environments, labeled with bounding boxes or segmentation masks indicating the locations and extents of the elements. In some embodiments, the model is trained to classify the type of support element (horizontal bar, vertical bar, angled bar, pole) and to estimate its position and orientation in the image.

The computer-vision models may use architectures such as YOLO (You Only Look Once), Faster R-CNN, or Mask R-CNN for object detection and segmentation. In some embodiments, the models are fine-tuned on a dataset of installer-submitted verification images with human verification labels, combined with synthetic images generated by rendering three-dimensional models of bathrooms with support elements in various configurations. In this way, the verification models are adapted to the specific visual characteristics of real-world installations and the articular support element types used in the system.

### Geometry Descriptor and Non-Reversible Fingerprint

Based on the one or more verification images, the system computes a geometry descriptor representing spatial relationships between at least one wall, at least one bathroom fixture, and the one or more installed support elements. The geometry descriptor encodes the relative positions and orientations of these elements in a structured format.

In some embodiments, the geometry descriptor includes measurements of distances between the installed support elements and identifiable reference points such as wall corners, fixture edges (e.g., bathtub rim, toilet base), and door frames. The geometry descriptor may also include angles representing the orientations of the support elements relative to walls or fixtures. In further embodiments, the geometry descriptor includes depth information derived from depth-enhanced images or estimated from monocular images using depth estimation neural networks.

The system generates a non-reversible fingerprint from the geometry descriptor. The non-reversible fingerprint is a cryptographic hash or one-way transformation of the geometry descriptor that cannot be reversed to recover the original geometry descriptor or the verification images. In some embodiments, the non-reversible fingerprint is generated by applying a cryptographic hash function such as SHA-256 to the geometry descriptor. In other embodiments, the non-reversible fingerprint is generated by applying a locality-sensitive hashing (LSH) function or a learned hash function that maps similar geometry descriptors to similar fingerprints while maintaining non-reversibility.

The use of a non-reversible fingerprint provides privacy benefits by allowing the system to store and compare geometric signatures of bathrooms without retaining the original verification images or geometry descriptors. This is particularly important for compliance with privacy regulations such as HIPAA (Health Insurance Portability and Accountability Act), as verification images may depict private spaces and personal health information. By retaining only the non-reversible fingerprint along with the job identifier and verification result, the system can perform verification and detect reuse of verification images across jobs by comparing fingerprints while limiting long-term retention of identifiable image data.

These mechanisms are particularly useful in environments where the images may depict private spaces and may be associated with protected health information (PHI). By relying primarily on non-reversible fingerprints and verification results for long-term recordkeeping, and by optionally de-identifying images before use in training data, the system supports adherence to privacy and data-minimization principles and can facilitate compliance with legal and regulatory frameworks such as the Health Insurance Portability and Accountability Act (HIPAA).

Comparison to Stored Verification Records and Detection of Image Reuse Using the detected job token and the non-reversible fingerprint, the system compares the one or more verification images to stored verification records for other jobs. This comparison determines: (1) whether the one or more verification images are associated with the job identifier indicated by the job token; and (2) whether the non-reversible fingerprint has been previously stored for a different job identifier, indicating potential reuse of verification images.

First, the system queries the database using the job identifier extracted from the job token to retrieve the installation plan and any previously stored verification records associated with that job identifier. If the job identifier matches an existing job in the database, the system confirms that the verification images are intended for that job. If the job identifier is not found or does not match the job for which verification is expected, the system flags a potential error or fraudulent submission.

Second, the system compares the non-reversible fingerprint computed from the current verification images to non-reversible fingerprints stored in the database for other job identifiers. If the system finds a matching or substantially similar fingerprint associated with a different job identifier, this indicates that the verification images may have been reused from a previous installation at a different location. Such reuse may occur if an installer attempts to submit verification images from a correctly completed installation to satisfy verification requirements for a different, incomplete, or incorrectly completed installation.

In some embodiments, the comparison uses exact matching fingerprints. In other embodiments, the comparison uses similarity measures to account for minor variations in geometry descriptors due to camera angle differences or measurement noise. If the similarity between the current fingerprint and a stored fingerprint exceeds a threshold, the system flags a potential reuse. In further embodiments, the system uses LSH or other approximate matching techniques to efficiently search for a large database of stored fingerprints for potential matches.

This fingerprint-based reuse detection provides a technical mechanism for ensuring the integrity of remote installation verification workflows. It prevents installers from reusing verification images across multiple jobs, thereby ensuring that each job is individually verified. This is particularly important in institutional settings such as nursing homes or assisted living facilities, where multiple bathrooms may have similar layouts and an installer might attempt to submit the same verification images for multiple installations.

### Comparison to Installation Plan and Conformance Determination

Based on the detected image regions corresponding to the one or more installed support elements and the installation plan associated with the job identifier, the system determines whether the location and orientation of each installed support element in the one or more verification images conforms to the expected location and orientation specified by the installation plan within at least one tolerance.

The installation plan specifies, for each support element, an expected location (e.g., coordinates relative to fixtures and walls) and an expected orientation (e.g., horizontal, vertical, angled at a specific angle). The system compares the detected location and orientation of each installed support element to the expected values, computing deviations or differences.

The system applies tolerance thresholds to determine whether the deviations are acceptable. For example, a tolerance of ±5 cm for position and ±5 degrees for orientation may be specified. If the detected location and orientation of an installed support element are within the specified tolerances of the expected values, the element is determined to conform to the installation plan. If the deviations exceed the tolerances, the element is flagged as non-conforming, and the system may prompt the installer to adjust the installation or provide additional documentation.

In some embodiments, the system uses computer-vision techniques to estimate the three-dimensional position and orientation of installed support elements from the two-dimensional verification images. This may involve estimating depth information, detecting reference points such as fixture edges and wall corners, and applying geometric transformations to map image coordinates to real-world coordinates. In further embodiments, the system uses multiple verification images captured from different angles to improve the accuracy of position and orientation estimation through triangulation or structure-from-motion techniques (e.g., a panning video of the room).

### Verification Result Output

The system outputs a verification result for the installation job. The verification result indicates at least: (1) whether the one or more verification images are associated with the job identifier and not reused from a different job; and (2) whether the installed support elements depicted in the one or more verification images conform to the installation plan within the at least one tolerance.

If the verification images are authentically associated with the job identifier, the non-reversible fingerprint does not match any stored fingerprints for other jobs, and all installed support elements conform to the installation plan within tolerances, the verification result indicates successful verification, and the system may issue a certificate of compliance. If any of these conditions are not satisfied, the verification result indicates a verification failure and specifies the reason for failure (e.g., job token mismatch, fingerprint reuse detected, support element non-conformance).

In some embodiments, the verification result includes detailed information such as: the job identifier; the installer identifier; timestamps indicating when the verification images were captured and when the verification was performed; the non-reversible fingerprint; detected positions and orientations of each installed support element; deviations from the expected positions and orientations; and conformance status (pass/fail) for each support element. This detailed information provides a comprehensive record of the verification process and supports quality control and auditing.

In further embodiments, the system stores the verification result and non-reversible fingerprint for long-term recordkeeping while limiting retention of the verification images in accordance with a defined retention policy. For example, the verification images may be retained for a limited period (e.g., 30 days) to allow for dispute resolution or quality review, and then deleted, while the non-reversible fingerprint and verification result are retained indefinitely. This approach balances the need for verification integrity with privacy considerations.

### Example Embodiment: Verification Workflow with Job Token and Geometry Fingerprint

In an example embodiment, an installer completes the installation of support elements in a bathroom according to an installation plan generated by the system. The installation plan specifies three support elements: a horizontal grab bar at the bathtub at a height of 90 cm above the bathtub floor and positioned 30 cm from the faucet end of the tub; a vertical grab bar at the bathtub entry at a height of 120 cm; and a grab bar to the right of the toilet at a height of 80 cm and positioned 30 cm from the toilet centerline.

The system generates a unique job token for this installation job, encoded as a QR code displayed on the installer's mobile device. The job token encodes a job identifier that uniquely identifies this bathroom installation. The installer is instructed to capture verification images of the installed support elements with the QR code visible in the images.

The installer captures three verification images: one showing the horizontal grab bar at the bathtub with the QR code visible on the mobile device screen positioned nearby; one showing the vertical grab bar at the bathtub entry with the QR code visible; and one showing the grab bar near the toilet with the QR code visible. The installer uploads the verification images to the system via the mobile application.

The system applies a computer-vision model to detect the QR code in each verification image. The model successfully detects the QR code and extracts the job identifier, confirming that the verification images are associated with the correct installation job.

The system applies a second computer-vision model to detect the installed support elements in the verification images. The model detects three grab bars and classifies them as: one horizontal bar, one vertical bar, and one horizontal bar, corresponding to the three support elements in the installation plan.

The system computes a geometry descriptor for the bathroom based on the verification images. The geometry descriptor includes measurements of the distances from each grab bar to identifiable reference points: the horizontal bar at the bathtub is 30 cm from the left edge of the bathtub (where the faucet is located) and 90 cm above the bathtub floor; the vertical bar at the bathtub entry is adjacent to the right edge of the bathtub and extends from 80 cm to 120 cm above the bathroom floor; the grab bar near the toilet is 30 cm to the right of the toilet centerline and 80 cm above the floor. The geometry descriptor also includes the spatial relationship between the bathtub and the toilet, measured as a distance of 100 cm between the bathtub edge and the toilet centerline.

The system generates a non-reversible fingerprint by applying the SHA-256 cryptographic hash function to the geometry descriptor. The resulting fingerprint is a 256-bit hash value that uniquely represents the bathroom geometry and installed support element configuration but cannot be reversed to recover the original geometry descriptor or verification images.

The system queries its database using the non-reversible fingerprint to check whether this fingerprint has been previously stored for a different job identifier. The query returns no matches, indicating that this bathroom geometry and support element configuration has not been submitted for verification for any other job. This confirms that the verification images are not reused from a previous installation.

The system compares the detected positions and orientations of the installed support elements to the expected values specified in the installation plan. The horizontal bar at the bathtub is detected at 89 cm height and 31 cm from the faucet end, which is within the specified tolerance of ±5 cm for both measurements. The vertical bar is detected at the correct position adjacent to the bathtub edge. The grab bar near the toilet is detected at 79 cm height and 29 cm from the toilet centerline, also within tolerances. All support elements conform to the installation plan.

The system outputs a verification result indicating successful verification: the verification images are associated with the correct job identifier, the non-reversible fingerprint is unique to this job, and all installed support elements conform to the installation plan within tolerances. The system stores the job identifier, installer identifier, non-reversible fingerprint, and verification result in the database for long-term recordkeeping, and issues a certificate of compliance to the installer.

### Training of Computer-Vision Models on Expert-Curated and Synthetic Data

The computer-vision models used for detecting job tokens and installed support elements, as well as the machine-learned models used for personalized planning and whole-room optimization, are trained on a training dataset comprising expert-curated examples and synthetic scenarios.

Expert-curated examples are derived from actual installation jobs performed by the system, where human experts such as occupational therapists, universal design specialists, or installation supervisors have reviewed and approved the installations. These examples include verification images of correctly installed support elements, associated installation plans, and human verification labels indicating conformance or non-conformance. By training on expert-curated examples, the models learn to recognize correct installation patterns and to identify deviations from those patterns.

Synthetic scenarios are generated using computer graphics and simulation techniques to create hypothetical bathrooms and support element configurations. A synthetic scenario generator applies expert-defined rules to generate bathroom geometries, functional profiles, and corresponding installation plans. The generator then renders three-dimensional models of bathrooms with support elements installed according to the plans and produces synthetic verification images from various camera angles and lighting conditions. These synthetic images are labeled with ground-truth information about support element types, positions, orientations, and conformance status.

The use of synthetic scenarios addresses the challenge of obtaining sufficient training data for rare or complex use cases, such as post-stroke users with right-side hemiparesis or high fall-risk users requiring whole-room optimization. By generating synthetic examples that cover a wide range of bathroom geometries, functional profiles, and support element configurations, the training dataset is enriched, and the models can generalize to new cases that may not have been encountered in actual installations.

In some embodiments, the synthetic scenario generator uses procedural generation techniques to create diverse bathroom layouts, varying in dimensions, fixture types, wall materials, and obstruction placements. The generator applies expert rules to determine appropriate support element configurations for each synthetic bathroom and functional profile, ensuring that the synthetic examples reflect established safety and design principles.

In further embodiments, the training dataset is augmented with variations of both expert-curated and synthetic examples, such as variations in camera angles, lighting conditions, image noise, and occlusions. Data augmentation techniques improve the robustness of the computer-vision models to real-world variability in verification images.

The training process for the machine-learned models uses supervised learning, reinforcement learning, or a combination of both. For supervised learning, the models are trained to predict installation plans or support element configurations given bathroom geometries and functional profiles, using the expert-curated and synthetic examples as training data. For reinforcement learning, the models are trained by simulating installation planning as a sequential decision-making process, where the model receives rewards for generating configurations that satisfy safety rules, cover critical transfer paths, and minimize the number of supports.

### Privacy Protection Through Metadata Stripping and Non-Reversible Fingerprints

In some embodiments, the system strips EXIF metadata from the verification images prior to storing the images and/or prior to using the images as training data for computer-vision models. EXIF metadata embedded in image files can include information such as GPS coordinates, camera make and model, timestamps, and camera settings. Such metadata may reveal the location of the bathroom and other identifying information that raises privacy concerns, particularly when verification images depict private residential spaces or are associated with individuals receiving healthcare services.

By stripping EXIF metadata before processing or storing verification images, the system protects user privacy and reduces the risk of inadvertent disclosure of location or other sensitive information. This metadata stripping is performed automatically upon receipt of verification images from the mobile device, before the images are used for computer-vision analysis, fingerprint generation, or long-term storage.

In further embodiments, the system retains only the non-reversible fingerprint and the verification result for long-term recordkeeping, rather than retaining the verification images themselves. This approach significantly reduces privacy risks by eliminating the storage of identifiable image data. The non-reversible fingerprint provides sufficient information to detect reuse of verification images and to verify that the same bathroom geometry has not been submitted for multiple jobs, without requiring retention of the images themselves.

This privacy-protective approach is particularly important for compliance with regulations such as HIPAA, which impose strict requirements on the collection, use, and storage of protected health information. By minimizing retention of identifiable image data and using non-reversible fingerprints, the system reduces the scope of information that may be subject to privacy regulations such as HIPAA and reduces the risk of privacy breaches.

### Edge Processing on Mobile Device

In some embodiments, at least a portion of the computer-vision processing and geometry descriptor computation is performed on the mobile device prior to uploading the verification images to the backend server. This edge processing approach reduces the amount of data transmitted over the network, reduces latency, and provides additional privacy protection by minimizing the transmission of raw verification images.

The mobile device may include a mobile application that incorporates lightweight versions of the computer-vision models for detecting job tokens and installed support elements. These lightweight models are optimized for execution on mobile processors with limited computational resources. Upon capturing verification images, the mobile application applies the models to detect the job token and support elements, computes the geometry descriptor, and generates the non-reversible fingerprint, all locally on the mobile device.

The mobile application then transmits the job identifier, geometry descriptor, and/or non-reversible fingerprint to the backend server, rather than transmitting the full verification images. The backend server uses the transmitted data to perform verification checks, such as comparing the non-reversible fingerprint to stored fingerprints for other jobs and comparing the detected support element positions to the installation plan. If the backend server requires the full verification images for detailed analysis or quality review, the images can be uploaded separately, but in many cases the transmitted data is sufficient for automated verification.

This edge processing approach provides the additional benefit of reducing bandwidth consumption and enabling verification in environments with limited or intermittent network connectivity. For typical installations corresponding to the default user population, the rules-based engine and associated hardware selections reside on the mobile device, and only the verification component needs to be uploaded. The certification can occur in real time when connectivity is available at the job site or after the fact when connectivity is restored. If the upload is performed in real time, any deviations can be identified and corrected on the spot until the installation passes inspection. In some embodiments, at least a portion of the augmented-reality (AR) visualization library also resides on the mobile device so that AR-based guidance for special populations and/or whole-room optimizations can be provided without continuous network connectivity.

### Computing System Architecture

Referring to FIG. L2, the system of the present invention includes one or more computer programs that are executable on a computer system including at least one processor coupled to receive data and instructions from, and to transmit data and instructions to, a data storage system, at least one input device, and at least one output device. The input devices may include but are not limited to an image-capturing device, depth sensor, lidar sensor, and a user interface operatively associated with the display of the computing system. Each computer program can be implemented in any suitable manner, including via a high-level procedural or object-oriented programming language and/or via assembly or machine language.

Systems of the present disclosure may include, by way of example, both general and special purpose microprocessors which may retrieve instructions and data to and from various types of volatile and/or non-volatile memory. Computer systems operating in conjunction with the embodiments of the present disclosure may include one or more mass storage devices for storing data files, which may include: magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware. The computer systems may include smartphones, tablets, or other similar devices.

In some embodiments, the computing system is a smartphone or tablet loaded with systemic software, downloaded from a network provider and installed in the device or pre-installed by the manufacturer. The computing system may be connected, by wired or wireless connection, to a network coupled to a database hosting dynamic link libraries or collections of programs that the systemic software can load as needed to complete specific tasks. In other embodiments, the software application and the database may reside in a terminal computing system or handheld computing device so that Internet connection is not required for the present invention to function.

The system may operate in a client-server architecture, wherein the mobile device operates as a client executing a mobile application that communicates with a backend server hosting the machine-learned models, rule-enforcement modules, verification modules, and databases. Alternatively, the system may operate in a distributed architecture, wherein portions of the processing are performed on the mobile device and other portions are performed on the backend server. The choice of architecture may be determined by factors such as computational resources available on the mobile device, network bandwidth and latency, and privacy considerations.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary. In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems include a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. A computer-implemented method for verifying installation of accessibility features including but not limited to support elements in a bathroom, the method comprising:
receiving, at one or more processors, site data and an installation plan for the bathroom, the installation plan specifying at least one planned support element and an expected location and orientation for the at least one planned support element;
associating a unique job token with a job identifier for an installation job, the job token being configured to be presented within a field of view of a camera during capture of verification images;
receiving, from a mobile device operated by an installer, one or more verification images of the bathroom captured after installation of one or more support elements, the one or more verification images comprising a visual representation of the job token and the one or more installed support elements;
detecting, by applying a computer-vision model to the one or more verification images: (i) an image region corresponding to the job token; and (ii) one or more image regions corresponding to the one or more installed support elements;
computing, based on the one or more verification images, a geometry descriptor representing spatial relationships between at least one wall, at least one bathroom fixture, and the one or more installed support elements, and generating a non-reversible fingerprint from the geometry descriptor;
comparing, using the job token and the non-reversible fingerprint, the one or more verification images to stored verification records, including comparing the fingerprint to stored fingerprints, for other jobs to determine whether the one or more verification images are associated with the job identifier and whether the non-reversible fingerprint has been previously stored for a different job identifier;
determining, based on the detected image regions corresponding to the one or more installed support elements and the installation plan, whether a location and orientation of each installed support element in the one or more verification images conforms to the expected location and orientation specified by the installation plan within at least one tolerance; and
outputting a verification result for the installation job, the verification result indicating at least whether the one or more verification images: (i) are associated with the job identifier and not reused from a different job; and (ii) depict an installation of the one or more support elements that conforms to the installation plan within the at least one tolerance.

2. The method of claim 1, further comprising performing at least a portion of the detecting and geometry descriptor computation on the mobile device prior to transmitting the one or more verification images to the one or more processors.

3. The method of claim 1, further comprising removing EXIF metadata from the one or more verification images prior to storing the one or more verification images.

4. The method of claim 1, further comprising retaining only the non-reversible fingerprint and the verification result for long-term records without retaining the one or more verification images.

5. A computer-implemented method for generating a personalized installation plan for accessibility features in a bathroom, the method comprising:
receiving, at one or more processors, site data describing a bathroom, the site data comprising at least locations and dimensions of one or more fixtures and structural information;
receiving, at one or more processors, a functional profile for an intended user, the functional profile comprising one or more parameters selected from: user height, reach range, hand dominance, use of a support element, balance or fall-risk classification, and side-specific strength or range-of-motion limitations;
inputting, by the one or more processors, the site data and the functional profile to a machine-learned model trained on a training dataset comprising expert-approved installation plans and associated functional profiles, wherein the machine-learned model outputs at least one candidate configuration of support elements;
constraining the at least one candidate configuration, using a rule-enforcement module, to satisfy a set of structural and safety rules derived from human-factors, universal-design, and construction experts; and
outputting installation instructions for the at least one candidate configuration, the installation instructions specifying, for each support element, at least a type, position, and orientation; and
wherein the method further comprises outputting a confidence score for the at least one candidate configuration and flagging configurations below a threshold for clinician review.

6. The method of claim 5, wherein the functional profile further comprises a cohort identifier associating the user with a group of similarly situated users.

7. The method of claim 5, wherein the training dataset further comprises synthetic scenarios generated by applying expert rules to hypothetical bathrooms and user profiles.

8. A computer-implemented method for optimizing placement of support elements throughout a bathroom or other area of the residence, the method comprising:
receiving, at one or more processors, site data describing geometry and fixtures of a bathroom, the site data comprising at least dimensions of the bathroom, locations of walls, doors, bathing fixtures, and toilets;
receiving a functional profile for an intended user, the functional profile comprising one or more parameters indicative of mobility limitations, balance or fall risk, side-specific weakness, or use of support elements;
determining, based on the site data and the functional profile, a set of candidate support elements comprising horizontal grab bars, vertical grab bars, angled grab bars, and floor-to-ceiling poles;
selecting, using a machine-learned model trained on expert-designed multi-support layouts, a subset of the candidate support elements and associated mounting locations to form a multi-support layout that optimizes at least one objective comprising coverage of critical transfer paths, number of supports, structural feasibility, or compliance with safety rules;
constraining the multi-support layout, using a rule-enforcement module, to satisfy structural and safety constraints; and
outputting installation instructions specifying, for each support element in the multi-support layout, a type, position, and orientation.

9. The method of claim 8, wherein the multi-support layout includes support elements positioned at locations other than adjacent to the bathing fixtures and toilets.

10. The method of claim 8, wherein the site data is derived at least in part from one or more sensors captured by a mobile device.

11. The method of claim 8, further comprising generating an augmented-reality visualization in which virtual representations of the selected support elements are superimposed on a live or recorded image of the bathroom.
